(19) United States
(12) Patent Application Publication
(10) Pub. No.: US 2015/0201345 A1
(43) Pub. Date: Jul. 16, 2015

(54) MEASUREMENT REPORT PROCESSING METHOD, BASE STATION, AND USER EQUIPMENT

(71) Applicant: HUAWEI TECHNOLOGIES CO., LTD., Shenzhen (CN)

(72) Inventors: Jian Zhang, Beijing (CN); Wei Quan, Beijing (CN); Yi Jiang, Shenzhen (CN)

(73) Assignee: HUAWEI TECHNOLOGIES CO., LTD., Shenzhen (CN)

(21) Appl. No.: 14/669,185

(22) Filed: Mar. 26, 2015

Related U.S. Application Data
(63) Continuation of application No. PCT/CN2012/082144, filed on Sep. 27, 2012.

(51) Int. Cl. H04W 24/10; H04W 72/14; H04L 12/26

(52) U.S. Cl. CPC H04W 24/10; H04L 43/06; H04W 72/14

(57) ABSTRACT

Embodiments of the present invention provide a measurement report processing method, a base station, and a user equipment. The processing method includes: sending a report indication message of a measurement report to a user equipment UE, and receiving a measurement report that is sent by the UE according to the report indication message. According to the measurement report processing method, the base station, and the user equipment that are provided in the embodiments of the present invention, the base station can obtain a measurement report in time, so as to save air interface resources.

### CROSS REFERENCE

This application is a continuation of International Application No. PCT/CN2012/082144, filed on Sep. 27, 2012, which is hereby incorporated by reference in its entirety.

### TECHNICAL FIELD

Embodiments of the present invention relate to communications technologies, and in particular, to a measurement report processing method, a base station, and a user equipment.

### BACKGROUND

In a wireless communications system, such as a Long Term Evolution (Long Term Evolution, LTE for short) system or a Universal Mobile Telecommunications System (Universal Mobile Telecommunications System, UMTS for short), cell reselection and cell handover are important functions of the wireless communications system. To implement the functions, a user equipment (User equipment, UE for short) needs to measure signal quality of different cells.

In the prior art, a measurement report is generally reported in an event trigger manner. A network side configures a measurement parameter and a measurement reporting parameter, where the measurement parameter includes a measurement object and the like, and the measurement reporting parameter includes an event type and a corresponding parameter for triggering measurement reporting. The UE evaluates measurement data according to a report event in a measurement configuration, and if a criterion for triggering the report event is met, the UE sends a measurement report to a base station, where the measurement report may include a measurement result of a serving cell and a neighboring cell.

In the prior art, the event trigger manner is adopted, and a trigger condition for reporting a measurement result determines whether the network side can acquire a measurement result of the UE in time. If it is very easy to meet the trigger condition, the UE frequently reports a measurement report, resulting in a huge waste of air interface resources. If it is very difficult to meet the trigger condition, the network side may fail to obtain the measurement report in time.

### SUMMARY

Embodiments of the present invention provide a measurement report processing method, a base station and a user equipment, which are used to enable the base station to obtain a measurement report in time, so as to save air interface resources.

According to one aspect, an embodiment of the present invention provides a measurement report processing method, including:

sending a report indication message of a measurement report to a user equipment UE, where the report indication message includes parameter information that needs to be measured and reported; and

receiving a measurement report that is sent by the UE according to the report indication message, where the measurement report includes measurement result information corresponding to the parameter information that needs to be measured and reported.

Further, the report indication message further includes uplink grant information allocated to the UE; and

the receiving a measurement report that is sent by the UE according to the report indication message includes:

receiving first measurement result information and identification information of the first measurement result information that are sent by the UE in a Medium Access Control protocol data unit MAC PDU that is encapsulated according to the uplink grant information; and

acquiring the first measurement result information according to the identification information of the first measurement result information.

Further, if padding exists in the MAC PDU, the report indication message further includes indication information that instructs the UE to send second measurement result information in the padding of the MAC PDU; and

the receiving a measurement report that is sent by the UE according to the report indication message further includes:

receiving the second measurement result information and identification information of the second measurement result information that are sent by the UE in the padding of the MAC PDU that is encapsulated according to the uplink grant information; and

acquiring the second measurement result according to the identification information of the second measurement result information.

Further, the report indication message further includes indication information that instructs the UE to send the measurement result information in the padding existing in a MAC PDU; and the receiving a measurement report that is sent by the UE according to the report indication message includes:

receiving the measurement result information and identification information of the measurement result information that are sent by the UE in the padding of the MAC PDU; and

acquiring a measurement result according to the identification information of the measurement result.

Further, the report indication message is a Radio Resource Control RRC message; and

the RRC message includes either of the following:

an RRC message that is created according to the RRC protocol; and

an RRC message that is obtained by adding an information element to the RRC message.

Further, the report indication message is a Medium Access Control MAC message.

Further, a measurement quantity in the measured and reported parameter includes any one or a combination of the following:

a configuration power headroom report; a configuration buffer status report; reference signal received power; reference signal received quality; and a received signal strength indicator.

An embodiment of the present invention further provides a measurement report processing method, including:

receiving a report indication message sent by a base station, where the report indication message includes parameter information that needs to be measured and reported; and

sending a measurement report to the base station according to the report indication message, where the measurement report includes measurement result information corresponding to the parameter information that needs to be measured and reported.

Further, the report indication message further includes uplink grant information; and

the sending a measurement report to the base station according to the report indication message includes:

encapsulating first measurement result information and identification information of the first measurement result information into a Medium Access Control protocol data unit MAC PDU corresponding to the uplink grant information and sending the first measurement result information and the identification information of the first measurement result information to the base station, so that the base station acquires the first measurement result information according to the identification information of the first measurement result information.

Further, if padding exists in the MAC PDU, the report indication message further includes indication information that instructs to send second measurement result information in the padding of the MAC PDU; and

the sending a measurement report to the base station according to the report indication message further includes:

encapsulating, according to a size of the padding and/or a preset priority of a measurement reporting parameter, the second measurement result information and identification information of the second measurement result information into the padding of the MAC PDU that is encapsulated according to the uplink grant information and sending the second measurement result information and the identification information of the second measurement result information to the base station, so that the base station acquires the second measurement result information according to the identification information of the second measurement result information.

Further, the report indication message further includes indication information that instructs to send the measurement result information in the padding existing in a MAC PDU; and

the sending a measurement report to the base station according to the report indication message includes:

encapsulating, according to a size of the padding and/or a preset priority of a measurement reporting parameter, the measurement result information and identification information of the measurement result information into the padding of the MAC PDU and sending the measurement result information and the identification information of the measurement result information to the base station, so that the base station acquires the measurement result information according to the identification information of the measurement result information.

Further, the report indication message is a Radio Resource Control RRC message; and

the RRC message includes either of the following:

an RRC message that is created according to the RRC protocol; and

an RRC message that is obtained by adding an information element to the RRC message.

Further, the report indication message is a Medium Access Control MAC message.

Further, a measurement quantity in the measured and reported parameter includes any one or a combination of the following:

a configuration power headroom report; a configuration buffer status report; reference signal received power; reference signal received quality; and a received signal strength indicator.

According to another aspect, an embodiment of the present invention provides a base station, including:

an indication sending module, configured to send a report indication message of a measurement report to a user equipment UE, where the report indication message includes parameter information that needs to be measured and reported; and

a report receiving module, configured to receive a measurement report that is sent by the UE according to the report indication message, where the measurement report includes measurement result information corresponding to the parameter information that needs to be measured and reported.

Further, the indication sending module is further configured to send uplink grant information allocated to the UE; and

the report receiving module is specifically configured to: receive first measurement result information and identification information of the first measurement result information that are sent by the UE in a Medium Access Control protocol data unit MAC PDU that is encapsulated according to the uplink grant information; and acquire the first measurement result information according to the identification information of the first measurement result information.

Further, the indication sending module is further configured to: if padding exists in the MAC PDU, instruct the UE to send second measurement result information in the padding of the MAC PDU; and

the report receiving module is further specifically configured to: receive the second measurement result information and identification information of the second measurement result information that are sent by the UE in the padding of the MAC PDU that is encapsulated according to the uplink grant information; and acquire the second measurement result according to the identification information of the second measurement result information.

Further, the indication sending module is further configured to instruct the UE to send the measurement result information in the padding existing in a MAC PDU; and

the report receiving module is specifically configured to: receive the measurement result information and identification information of the measurement result information that are sent by the UE in the padding of the MAC PDU; and acquire a measurement result according to the identification information of the measurement result.

Further, the report indication message is a Radio Resource Control RRC message; and

the RRC message includes either of the following:

an RRC message that is created according to the RRC protocol; and

an RRC message that is obtained by adding an information element to the RRC message.

Further, the report indication message is a Medium Access Control MAC message.

Further, a measurement quantity in the measured and reported parameter includes any one or a combination of the following:

a configuration power headroom report; a configuration buffer status report; reference signal received power; reference signal received quality; and a received signal strength indicator.

According to still another aspect, an embodiment of the present invention provides a user equipment, including:

an indication receiving module, configured to receive a report indication message sent by a base station, where the report indication message includes parameter information that needs to be measured and reported; and

a report sending module, configured to send a measurement report to the base station according to the report indication message, where the measurement report includes measurement result information corresponding to the parameter information that needs to be measured and reported.

Further, the indication receiving module is further configured to receive uplink grant information; and

the report sending module is specifically configured to encapsulate first measurement result information and identification information of the first measurement result information into a Medium Access Control protocol data unit MAC PDU that is encapsulated according to the uplink grant information and send the first measurement result information and the identification information of the first measurement result information to the base station, so that the base station acquires the first measurement result information according to the identification information of the first measurement result information.

Further, the indication receiving module is further configured to receive indication information that instructs to send second measurement result information in padding of the MAC PDU; and

the report sending module is further specifically configured to encapsulate, according to a size of the padding and/or a preset priority of a measurement reporting parameter, the second measurement result information and identification information of the second measurement result information into the padding of the MAC PDU that is encapsulated according to the uplink grant information and send the second measurement result information and the identification information of the second measurement result information to the base station, so that the base station acquires the second measurement result information according to the identification information of the second measurement result information.

Further, the indication receiving module is further configured to receive indication information that instructs to send the measurement result information in the padding existing in a MAC PDU; and

the report sending module is specifically configured to encapsulate, according to a size of the padding and/or a preset priority of a measurement reporting parameter, the measurement result information and identification information of the measurement result information into the padding of the MAC PDU and send the measurement result information and the identification information of the measurement result information to the base station, so that the base station acquires the measurement result information according to the identification information of the measurement result information.

Further, the report indication message is a Radio Resource Control RRC message; and

the RRC message includes either of the following:

an RRC message that is created according to the RRC protocol; and

an RRC message that is obtained by adding an information element to the RRC message.

Further, the report indication message is a Medium Access Control MAC message.

Further, a measurement quantity in the measured and reported parameter includes any one or a combination of the following:

a configuration power headroom report; a configuration buffer status report; reference signal received power; reference signal received quality; and a received signal strength indicator.

According to yet another aspect, an embodiment of the present invention provides a base station, including a processor and a memory, where the memory stores an execution instruction; and when the base station runs, the processor communicates with the memory, and the processor executes the execution instruction to enable the base station to perform the foregoing method.

An embodiment of the present invention further provides a user equipment, including a processor and a memory, where the memory stores an execution instruction; and when the user equipment runs, the processor communicates with the memory, and the processor executes the execution instruction to enable the user equipment to perform the foregoing method.

In the embodiments of the present invention, a base station sends a report indication message of a measurement report to a user equipment UE and receives a measurement report that is sent by the UE according to the report indication message. In this way, a required measurement report can be obtained in time, and a waste of air interface resources is avoided.

### BRIEF DESCRIPTION OF DRAWINGS

To describe the technical solutions in the embodiments of the present invention more clearly, the following briefly introduces the accompanying drawings required for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 is a flowchart of Embodiment 1 of a measurement report processing method according to the present invention;

FIG. 2 is a flowchart of Embodiment 2 of a measurement report processing method according to the present invention;

FIG. 3 is a flowchart of Embodiment 3 of a measurement report processing method according to the present invention;

FIG. 4 is a schematic diagram of a format of a MAC PDU of Embodiment 4 of a measurement report processing method according to the present invention;

FIG. 5 is a flowchart of Embodiment 5 of a measurement report processing method according to the present invention;

FIG. 6 is a flowchart of Embodiment 6 of a measurement report processing method according to the present invention;

FIG. 7 is a flowchart of Embodiment 7 of a measurement report processing method according to the present invention;

FIG. 8 is a flowchart of Embodiment 8 of a measurement report processing method according to the present invention;

FIG. 9 is a flowchart of Embodiment 9 of a measurement report processing method according to the present invention;

FIG. 10 is a schematic structural diagram of Embodiment 1 of a base station according to the present invention;

FIG. 11 is a schematic structural diagram of Embodiment 1 of a user equipment according to the present invention;

FIG. 12 is a schematic structural diagram of Embodiment 2 of a base station according to the present invention; and

FIG. 13 is a schematic structural diagram of Embodiment 2 of a user equipment according to the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by persons of ordinary skill in the art based on the embodiments of the present invention without creative efforts shall fall within the protection scope of the present invention.

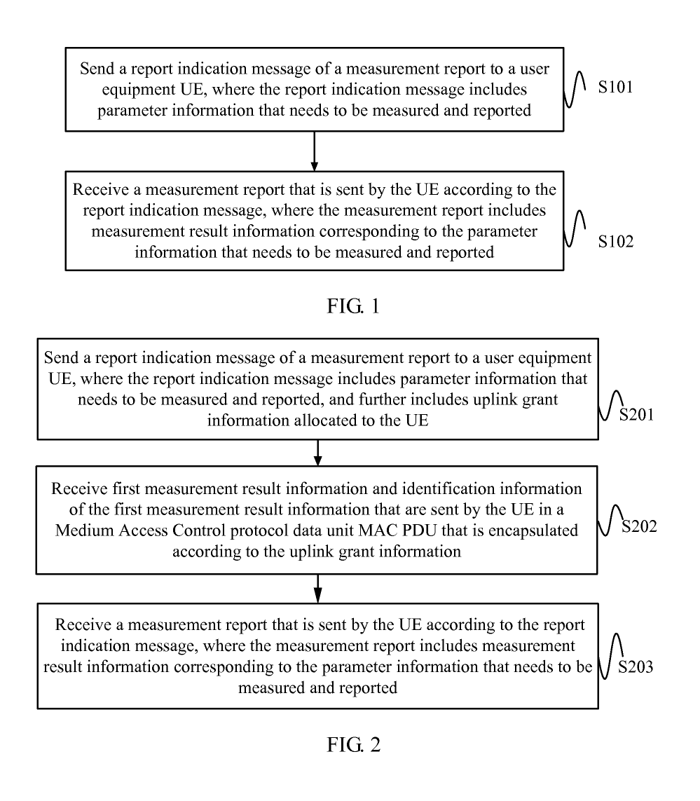

FIG. 1 is a flowchart of Embodiment 1 of a measurement report processing method according to the present invention. As shown in FIG. 1, in this embodiment, a base station is used as an execution body to describe the measurement report processing method. The base station in this instance may be an evolved base station (Evolved Node B, hereinafter briefly referred to as eNB or eNodeB) in LTE. The measurement report processing method in this embodiment includes:

Step S101: Send a report indication message of a measurement report to a user equipment UE, where the report indication message includes parameter information that needs to be measured and reported.

Step S102: Receive a measurement report that is sent by the UE according to the report indication message, where the measurement report includes measurement result information corresponding to the parameter information that needs to be measured and reported.

In a specific implementation process, the base station first configures a measurement parameter, and the measurement parameter includes multiple measurement objects and measurement quantities, and the like that need to be measured by the UE, so that the UE performs a corresponding measurement according to the measurement parameter configured by the base station. A scenario in which the base station acquires a related measurement result may be any one or a combination of the following scenarios: When scheduling more data volumes for the UE, the base station needs to acquire power headroom information of the UE; the base station needs to acquire signal quality of a neighboring cell to offload data of the UE to the neighboring cell; the base station needs to acquire interference situations coexisting in the UE; and the base station needs to acquire position information of the UE. This embodiment of the present invention sets no special limitation on the scenario in which the base station needs to acquire the related measurement result.

When the base station needs to obtain the related measurement result according to an actual scenario, the base station sends the report indication message of the measurement report to the UE, where the report indication message may include the parameter information that the base station requires the UE to report, and the parameter information may be a measurement quantity, a measurement object, and the like in the measurement report reported by the UE.

After receiving the report indication message, the UE may request an uplink grant from the base station, where the uplink grant is allocated by the base station to the UE. The UE may obtain, according to time domain and frequency domain resources, a modulation and coding scheme, and the like in the uplink grant, a size of a Medium Access Control (Medium Access Control, MAC for short) protocol data unit (Protocol Data Unit, PDU for short) used for uplink transmission, encapsulate, into an uplink MAC PDU, a measurement report that needs to be reported, and transmit the measurement report to the base station.

The base station receives the measurement report that is sent by the UE according to the report indication message, where the measurement report includes the measurement result information corresponding to the parameter information that needs to be measured and reported, and the base station performs a subsequent operation according to the measurement result information.

In this embodiment of the present invention, a base station sends a report indication message of a measurement report to a user equipment UE and receives a measurement report that is sent by the UE according to the report indication message. In this way, a required measurement report can be obtained in time, and a waste of air interface resources is avoided.

FIG. 2 is a flowchart of Embodiment 2 of a measurement report processing method according to the present invention. As shown in FIG. 2, in this embodiment, a base station is used as an execution body to describe the measurement report processing method, and the measurement report processing method in this embodiment includes:

Step S201: Send a report indication message of a measurement report to a user equipment UE, where the report indication message includes parameter information that needs to be measured and reported, and further includes uplink grant information allocated to the UE.

Step S202: Receive first measurement result information and identification information of the first measurement result information that are sent by the UE in a Medium Access Control protocol data unit MAC PDU that is encapsulated according to the uplink grant information.

Step S203: Acquire the first measurement result information according to the identification information of the first measurement result information.

On the basis of the foregoing embodiment in FIG. 1, in this embodiment of the present invention, the report indication message may further include the uplink grant information allocated to the UE. The uplink grant information includes a physical resource, a modulation and coding scheme, and the like for performing uplink data transmission by the UE. The UE may acquire, according to the uplink grant information, a size of the MAC PDU used for the uplink transmission, encapsulate the first measurement result information and the identification information of the first measurement result information that are required by the base station into the MAC PDU, and send the first measurement result information and the identification information of the first measurement result information to the base station. The identification information of the first measurement result information may be identification information of a logical channel and type information of a measurement result, and the base station acquires the first measurement result information according to the identification information of the first measurement result information.

In this embodiment of the present invention, a report indication message of a measurement report is sent to a user equipment UE, where the report indication message includes parameter information that needs to be measured and reported and uplink grant information allocated to the UE, so that after receiving the report indication message sent by the base station, the UE may transmit related data of measurement result information to the base station according to the uplink grant information. In this way, there is no need to request physical resources used for data transmission from the base station, and air interface resources are also saved.

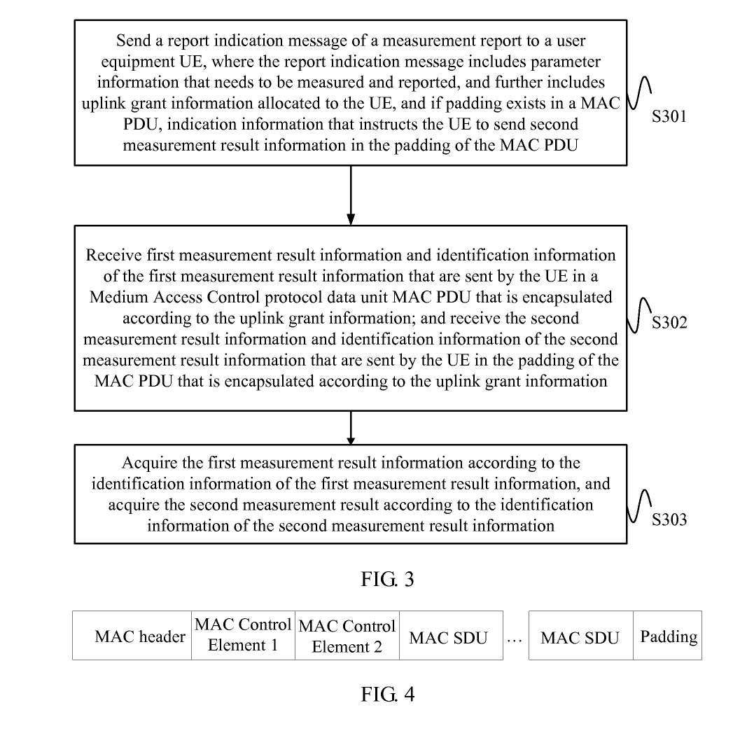

FIG. 3 is a flowchart of Embodiment 3 of a measurement report processing method according to the present invention. As shown in FIG. 3, in this embodiment, a base station is used as an execution body to describe the measurement report processing method, and the measurement report processing method in this embodiment includes:

Step S301: Send a report indication message of a measurement report to a user equipment UE, where the report indication message includes parameter information that needs to be measured and reported, and further includes uplink grant information allocated to the UE, and if padding exists in a MAC PDU, indication information that instructs the UE to send second measurement result information in the padding of the MAC PDU.

Step S302: Receive first measurement result information and identification information of the first measurement result information that are sent by the UE in a Medium Access Control protocol data unit MAC PDU that is encapsulated according to the uplink grant information; and receive the second measurement result information and identification information of the second measurement result information that are sent by the UE in the padding of the MAC PDU that is encapsulated according to the uplink grant information.

Step S303: Acquire the first measurement result information according to the identification information of the first measurement result information, and acquire the second measurement result according to the identification information of the second measurement result information.

FIG. 4 is a schematic diagram of a format of a MAC PDU. As shown in FIG. 4, the MAC PDU includes a MAC PDU header, zero or more MAC control elements (Control Element, CE for short), zero or more Medium Access Control service data units MAC SDUs (Service Data Unit, SDU for short), and padding.

The padding is located in a MAC PDU trailer, and the padding may be any value. When the padding is in the MAC PDU trailer, zero or more padding bytes are allowed. When padding of one byte or two bytes needs to be added, one or two subheaders corresponding to the padding are placed at a start position of the MAC PDU and precede other subheaders.

In a specific implementation process, the UE may acquire, according to the uplink grant information, a size of the MAC PDU used for uplink transmission, encapsulate the first measurement result information and the identification information of the first measurement result information that are required by the base station into the MAC PDU, and send the first measurement result information and the identification information of the first measurement result information to the base station. In addition, when the padding exists in the MAC PDU, the UE may encapsulate the second measurement result information and the identification information of the second measurement result information into the padding of the MAC PDU according to a size of the padding or a preset priority of a reported measurement parameter or a combination of the two, and send the second measurement result information and the identification information of the second measurement result information to the base station, where the identification information of the second measurement result information may be a logical channel identifier and is used to identify the padding and a measurement report. Persons skilled in the art may understand that, the sending of the first measurement result information to the base station by the UE is performed by the UE according to the parameter information that needs to be measured and reported. When the padding exists in the MAC PDU, the base station instructs the UE to send the second measurement result information in the padding of the MAC PDU. This embodiment of the present invention sets no specific limitation on a measurement object and a measurement quantity in the measurement report that are specifically reported for the second measurement result, which may be implemented by instructing the UE by the base station, and the UE may also choose, according to the preset priority of the measurement parameter, one or more measurement reports that can be accommodated in the padding. For brevity, that is, when the UE sends the measurement report required by the base station to the base station, if the padding exists, the base station carries some measurement reports in the padding and sends the measurement reports to the base station.

The base station receives the second measurement result information and the identification information of the second measurement result information that are sent by the UE in the padding of the MAC PDU that is encapsulated according to the uplink grant information, and the base station may acquire the second measurement result according to the identification information of the second measurement result information.

In this embodiment of the present invention, a base station may receive a first measurement report that is sent by a UE in a MAC PDU, and a second measurement report that is sent in padding of the MAC PDU. In this way, the base station not only can acquire a required measurement report, but also can fully use radio resources.

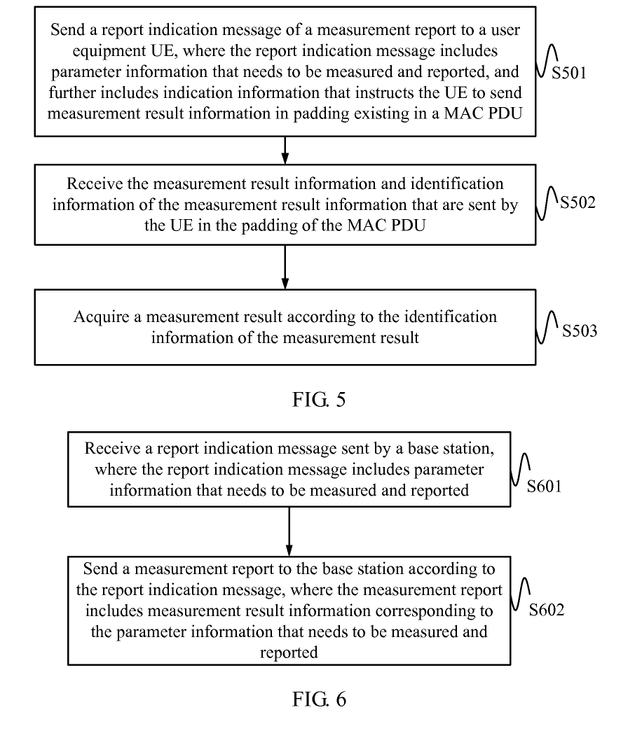

FIG. 5 is a flowchart of Embodiment 5 of a measurement report processing method according to the present invention. As shown in FIG. 5, in this embodiment, a base station is used as an execution body to describe the measurement report processing method, and the measurement report processing method in this embodiment includes:

Step S501: Send a report indication message of a measurement report to a user equipment UE, where the report indication message includes parameter information that needs to be measured and reported, and further includes indication information that instructs the UE to send measurement result information in padding existing in a MAC PDU.

Step S502: Receive the measurement result information and identification information of the measurement result information that are sent by the UE in the padding of the MAC PDU.

Step S503: Acquire a measurement result according to the identification information of the measurement result.

In a specific implementation process, on the basis of the embodiment in FIG. 1, in this embodiment of the present invention, the report indication message sent by the base station to the UE further includes the indication information that instructs the UE to send the measurement result information in the padding existing in the MAC PDU. That the UE sends the measurement result information in the padding existing in the MAC PDU may include two cases. One case is that after receiving the report indication message, the UE may request an uplink grant from the base station, where the uplink grant is allocated by the base station to the UE. The UE may obtain, according to time domain and frequency domain resources, a modulation and coding scheme, and the like in the uplink grant, a size of the Medium Access Control protocol data unit MAC PDU used for uplink transmission, encapsulate the reported measurement report and identification information of the measurement report that are required by the base station into an uplink MAC PDU, and encapsulate, by means of carrying, another measurement report and identification information of the measurement report into the padding existing in the uplink MAC PDU. The other case is that the UE makes a call, sends a short message service message, surfs the Internet, and the like, and the UE sends uplink data to the base station in the MAC PDU. If the padding exists in the MAC PDU, the UE may also send one or more measurement reports in the padding according to a preset priority of a measurement parameter, or when the padding can accommodate one or more measurement reports and identification information of the measurement reports, the UE encapsulates the one or more measurement reports and the identification information of the measurement reports into the padding. This case may be understood as that after using padding to carry a measurement report is configured in the base station, the UE can encapsulate the measurement report into the padding existing in the MAC PDU.

Optionally, the measurement object and the measurement quantity in the measurement report that is reported in the padding may be indicated by the base station. For example, the foregoing report indication message may be used to perform the instructing, and the report indication message may be a configuration message, that is, information about the measurement object and the measurement quantity in the measurement report that is reported by using the padding is configured. The measurement object and the measurement quantity may also be stipulated in a protocol, for example, the protocol may stipulate that the UE may use the padding to encapsulate all measured measurement reports configured by the base station, which is not specially limited in this embodiment of the present invention.

Optionally, the preset priority, that is, a priority of the measurement result information sent by using the padding may be indicated by using the foregoing report indication message, where the report indication message may include a configuration message, that is, a sending priority of the measurement report that may be reported by using the padding is configured. The preset priority may also be stipulated in a protocol, for example, sending priorities of all possible measurement results may be stipulated in the protocol, which is not specially limited in this embodiment of the present invention.

The base station receives measurement result information and identification information of the measurement result that are sent by the UE in the MAC PDU and/or receives the measurement result information and the identification information of the measurement result that are sent by the UE in the padding existing in the MAC PDU, and acquires the measurement result according to the identification information of the measurement result.

In particular, this embodiment may be independent of Embodiment 1 for use, that is, the report indication message includes the parameter information that needs to be measured and reported, for example, information about a measurement object and a measurement quantity in the measurement report that is reported by using the padding and/or a sending priority of the measurement report that is reported by using the padding is configured, and the measurement result information and the identification information of the measurement result that are sent, when the padding exists in the MAC PDU, by the UE in the padding according to the report indication message are received, and the measurement result is acquired according to the identification information of the measurement result.

In this embodiment of the present invention, a base station may receive a required measurement report that is sent by a UE in a MAC PDU, and may further receive a measurement report that is sent by a UE in padding of the MAC PDU. In this way, the base station not only can acquire the required measurement report, but also can fully use radio resources.

In the foregoing embodiments in FIG. 1 to FIG. 5, the foregoing report indication message may be a Radio Resource Control (Radio Resource Control, RRC for short) message, and the RRC message includes either of the following:

an RRC message that is created according to the RRC protocol; and

an RRC message that is obtained by adding an information element to the RRC message.

A new RRC message may be created according to the RRC protocol, and the information element may further be added to the RRC message. For the RRC message, the UE may encapsulate the measurement report required by the base station into the MAC PDU by using the measurement report as a MAC SDU.

In this embodiment of the present invention, by using the RRC message, control signaling transmission between the UE and the base station can be implemented, where the RRC message carries all parameters of the report indication message.

In the foregoing embodiments in FIG. 1 to FIG. 5, the report indication message is a Medium Access Control MAC message. For the MAC message, the UE may encapsulate the measurement report required by the base station into the MAC PDU by using the measurement report as a MAC CE, and encapsulate identification information that is used for identifying a type of the MAC CE and the padding into a MAC PDU header, so that the base station can acquire the measurement report according to the identification information.

In this embodiment of the present invention, by using the MAC message, control signaling transmission between the UE and the base station can be implemented, where the MAC message carries all parameters of the report indication message.

In the foregoing embodiments, a measurement quantity in the measured and reported parameter includes any one or a combination of the following: a configuration power headroom report; a configuration buffer status report; reference signal received power; reference signal received quality; and a received signal strength indicator.

In this embodiment of the present invention, the measurement quantity in the reported measurement parameter includes any one or a combination of the following: the configuration power headroom report, the configuration buffer status report, the reference signal received power, the reference signal received quality, and the received signal strength indicator, and covers measurement reports required by the base station in various scenarios. Persons skilled in the art may understand that, the measurement quantity may further be a measurement quantity that needs to be obtained by another eNB, such as location information, which is not specially limited in this embodiment of the present invention.

FIG. 6 is a flowchart of Embodiment 6 of a measurement report processing method according to the present invention. As shown in FIG. 6, in this embodiment of the present invention, a user equipment (User equipment, UE for short) is used as an execution body to describe the measurement report processing method, and the measurement report processing method in this embodiment includes:

Step S601: Receive a report indication message sent by a base station, where the report indication message includes parameter information that needs to be measured and reported.

Step S602: Send a measurement report to the base station according to the report indication message, where the measurement report includes measurement result information corresponding to the parameter information that needs to be measured and reported.

In a specific implementation process, the UE first performs a related measurement according to a measurement parameter configured by the base station, where the measurement parameter includes multiple measurement objects and measurement quantities and the like that need to be measured by the UE. When the base station needs to acquire a related measurement result, the base station sends the report indication message to the UE.

After receiving the report indication message, the UE may request an uplink grant from the base station, where the uplink grant is allocated by the base station to the UE. The UE may obtain, according to time domain and frequency domain resources, a modulation and coding scheme, and the like in the uplink grant, a size of a Medium Access Control protocol data unit MAC PDU used for uplink transmission, encapsulate, according to the report indication message, a reported measurement report that is required by the base station into an uplink MAC PDU, and transmit a measurement result to the base station.

In this embodiment of the present invention, a user equipment receives a report indication message sent by a base station, and sends a measurement report to the base station according to the report indication message. In this way, a required measurement report can be obtained in time, and a waste of air interface resources is avoided.

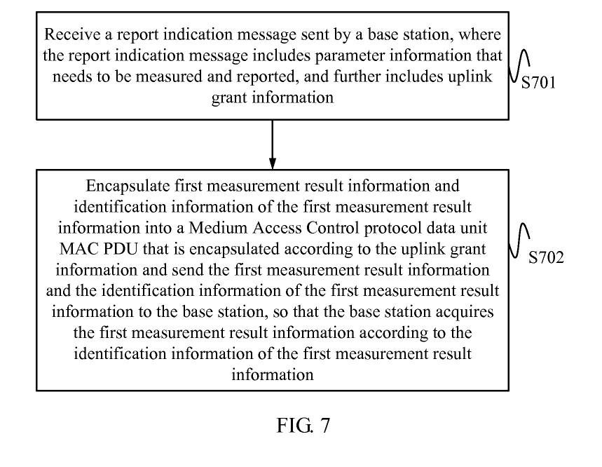

FIG. 7 is a flowchart of Embodiment 7 of a measurement report processing method according to the present invention. As shown in FIG. 7, in this embodiment of the present invention, a UE is used as an execution body to describe the measurement report processing method, and the measurement report processing method in this embodiment includes:

Step S701: Receive a report indication message sent by a base station, where the report indication message includes parameter information that needs to be measured and reported, and further includes uplink grant information.

Step S702: Encapsulate first measurement result information and identification information of the first measurement result information into a Medium Access Control protocol data unit MAC PDU that is encapsulated according to the uplink grant information and send the first measurement result information and the identification information of the first measurement result information to the base station, so that the base station acquires the first measurement result information according to the identification information of the first measurement result information.

On the basis of the embodiment in FIG. 6, in this embodiment of the present invention, the report indication message may further include the uplink grant information allocated to the UE. The uplink grant information includes a physical resource, a modulation and coding scheme, and the like for performing uplink data transmission by the UE. The UE may acquire, according to the uplink grant information, a size of the MAC PDU used for the uplink transmission, encapsulate the first measurement result information and the identification information of the first measurement result information that are required by the base station into the MAC PDU, and send the first measurement result information and the identification information of the first measurement result information to the base station. The identification information of the first measurement result information may be identification information of a logical channel and type information of a measurement result, and the base station acquires the first measurement result information according to the identification information of the first measurement result information.

In this embodiment of the present invention, a UE receives a report indication message sent by a base station, where the report indication message includes parameter information that needs to be measured and reported, and uplink grant information allocated to the UE, and the UE may transmit related data of measurement result information to the base station according to the uplink grant information. In this way, there is no need to request physical resources used for data transmission from the base station, and air interface resources are also saved.

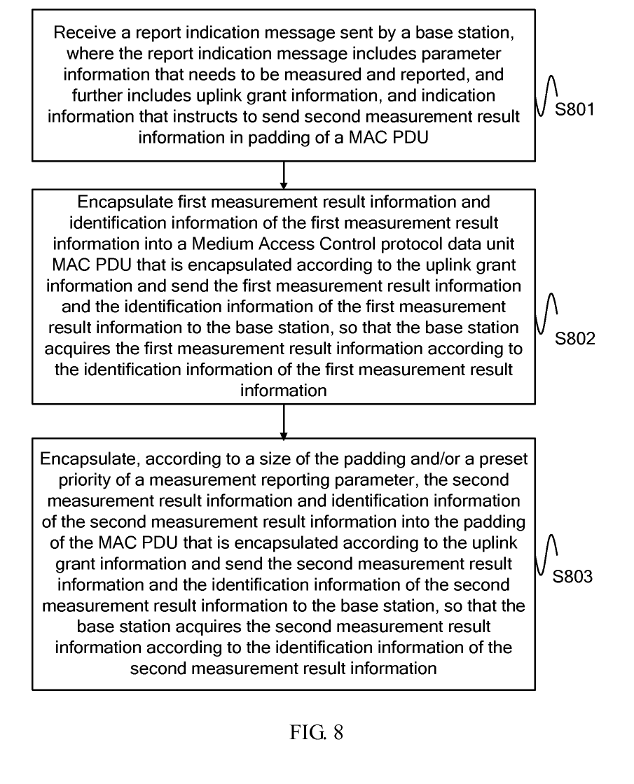

FIG. 8 is a flowchart of Embodiment 8 of a measurement report processing method according to the present invention. As shown in FIG. 8, in this embodiment of the present invention, a UE is used as an execution body to describe the measurement report processing method, and the measurement report processing method in this embodiment includes:

Step S801: Receive a report indication message sent by a base station, where the report indication message includes parameter information that needs to be measured and reported, and further includes uplink grant information, and indication information that instructs to send second measurement result information in padding of a MAC PDU.

Step S802: Encapsulate first measurement result information and identification information of the first measurement result information into a Medium Access Control protocol data unit MAC PDU that is encapsulated according to the uplink grant information and send the first measurement result information and the identification information of the first measurement result information to the base station, so that the base station acquires the first measurement result information according to the identification information of the first measurement result information.

Step S803: Encapsulate, according to a size of the padding and/or a preset priority of a measurement reporting parameter, the second measurement result information and identification information of the second measurement result information into the padding of the MAC PDU that is encapsulated according to the uplink grant information and send the second measurement result information and the identification information of the second measurement result information to the base station, so that the base station acquires the second measurement result information according to the identification information of the second measurement result information.

In a specific implementation process, on the basis of the embodiment in FIG. 7, in this embodiment of the present invention, the UE may acquire, according to the uplink grant information, a size of the MAC PDU used for uplink transmission, encapsulate the first measurement result information and the identification information of the first measurement result information that are required by the base station into the MAC PDU, and send the first measurement result information and the identification information of the first measurement result information to the base station. In addition, when the padding exists in the MAC PDU, the UE may encapsulate the second measurement result information and the identification information of the second measurement result information into the padding of the MAC PDU according to a size of the padding or a preset priority of a reported measurement parameter or a combination of the two, and send the second measurement result information and the identification information of the second measurement result information to the base station, where the identification information of the second measurement result information may be a logical channel identifier and is used to identify the padding and a measurement report. The preset priority, for example, may be that reference signal received power is greater than reference signal received quality, and the reference signal received quality is greater than a received signal strength indicator. If accommodation space of the padding is limited, the UE preferentially chooses to encapsulate the reference signal received power into a padding bit. Persons skilled in the art may understand that, the sending of the first measurement result information to the base station by the UE is performed by the UE according to the parameter information that needs to be measured and reported. When the padding exists in the MAC PDU, the base station instructs the UE to send the second measurement result information in the padding of the MAC PDU. This embodiment of the present invention sets no specific limitation on a measurement object and a measurement quantity in the measurement report that are specifically reported for the second measurement result, which may be implemented by instructing the UE by the base station, and the UE may also choose, according to the preset priority of the measurement parameter, one or more measurement reports that can be accommodated in the padding. For brevity, that is, when the UE sends the measurement report required by the base station to the base station, if the padding exists, the base station carries some measurement reports in the padding and sends the measurement reports to the base station. Persons skilled in the art may understand that, the foregoing steps S802 and S803 may be performed at the same time, and there is no time sequence.

In this embodiment of the present invention, a UE sends a first measurement report in a MAC PDU, and sends a second measurement report in padding of the MAC PDU. In this way, a base station not only can acquire a required measurement report, but also can fully use radio resources.

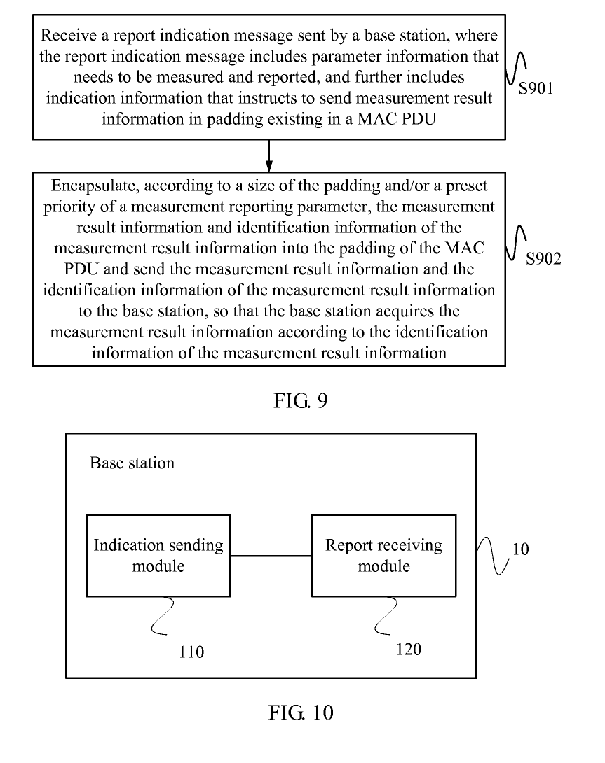

FIG. 9 is a flowchart of Embodiment 9 of a measurement report processing method according to the present invention. As shown in FIG. 9, in this embodiment of the present invention, a UE is used as an execution body to describe the measurement report processing method, and the measurement report processing method in this embodiment includes:

Step S901: Receive a report indication message sent by a base station, where the report indication message includes parameter information that needs to be measured and reported, and further includes indication information that instructs to send measurement result information in padding existing in a MAC PDU.

Step S902: Encapsulate, according to a size of the padding and/or a preset priority of a measurement reporting parameter, the measurement result information and identification information of the measurement result information into the padding of the MAC PDU and send the measurement result information and the identification information of the measurement result information to the base station, so that the base station acquires the measurement result information according to the identification information of the measurement result information.

In a specific implementation process, on the basis of the embodiment in FIG. 6, in this embodiment of the present invention, the report indication message sent by the base station to the UE further includes the indication information that instructs the UE to send the measurement result information in the padding existing in the MAC PDU. That the UE sends the measurement result information in the padding existing in the MAC PDU may include two cases. One case is that after receiving the report indication message, the UE may request an uplink grant from the base station, where the uplink grant is allocated by the base station to the UE. The UE may obtain, according to time domain and frequency domain resources, a modulation and coding scheme, and the like in the uplink grant, a size of the Medium Access Control protocol data unit MAC PDU used for uplink transmission, encapsulate the reported measurement report and identification information of the measurement report that are required by the base station into an uplink MAC PDU, and encapsulate, by means of carrying, another measurement report and identification information of the measurement report into the padding existing in the uplink MAC PDU. The other case is that the UE makes a call, sends a short message service message, surfs the Internet, and the like, and the UE sends uplink data to the base station in the MAC PDU. If the padding exists in the MAC PDU, the UE may also send one or more measurement reports in the padding according to a preset priority of a measurement parameter, or when the padding can accommodate one or more measurement reports and identification information of the measurement reports, the UE encapsulates the one or more measurement reports and the identification information of the measurement reports into the padding. This case may be understood as that after using padding to carry a measurement report is configured in the base station, the UE can further encapsulate the measurement report into the padding existing in the MAC PDU.

Optionally, the measurement object and the measurement quantity in the measurement report that is reported in the padding may be implemented by instructing the UE by the base station. For example, the foregoing report indication message may be used to perform the instructing, and the report indication message may be a configuration message, that is, information about the measurement object and the measurement quantity in the measurement report that is reported by using the padding is configured. The measurement object and the measurement quantity may also be stipulated in a protocol, for example, the protocol may stipulate that the UE may use the padding to encapsulate all measured measurement reports configured by the base station, which is not specially limited in this embodiment of the present invention.

Optionally, the preset priority, that is, a priority of the measurement result information sent by using the padding may be indicated by using the foregoing report indication message, where the report indication message may include a configuration message, that is, a sending priority of the measurement report that may be reported by using the padding is configured. The preset priority may also be stipulated in a protocol, for example, sending priorities of all possible measurement results may be stipulated in the protocol, which is not specially limited in this embodiment of the present invention.

In particular, this embodiment may be used independently, that is, the UE receives the parameter information that is included in the report indication message sent by the eNB and needs to be measured and reported, for example, the parameter information such as information about a measurement object and a measurement quantity in the measurement report that is reported by using the padding and/or a sending priority of the measurement report that is reported by using the padding is received, and when the padding exists in the MAC PDU, the measurement result information and the identification information of the measurement result are sent to the eNB in the padding according to the report indication message, so that the eNB acquires the measurement result according to the identification information of the measurement result.

In this embodiment of the present invention, a UE may send a required measurement report in a MAC PDU, and may further send a measurement report in padding of the MAC PDU. In this way, a base station not only can acquire the required measurement report, but also can fully use radio resources.

In the foregoing embodiments in FIG. 6 to FIG. 9, the foregoing report indication message may be a Radio Resource Control (Radio Resource Control, RRC for short) message, and the RRC message includes either of the following:

an RRC message that is created according to the RRC protocol; and

an RRC message that is obtained by adding an information element to the RRC message.

A new RRC message may be created according to the RRC protocol, and the information element may further be added to the RRC message. For the RRC message, the UE may encapsulate the measurement report required by the base station into the MAC PDU by using the measurement report as a MAC SDU.

In this embodiment of the present invention, by using the RRC message, control signaling transmission between the UE and the base station can be implemented, where the RRC message carries all parameters of the report indication message.

In the foregoing embodiments in FIG. 6 to FIG. 9, the report indication message is a Medium Access Control MAC message. For the MAC message, the UE may encapsulate the measurement report required by the base station into the MAC PDU by using the measurement report as a MAC CE, and encapsulate identification information that is used for identifying a type of the MAC CE and the padding into a MAC PDU header, so that the base station can acquire the measurement report according to the identification information.

In this embodiment of the present invention, by using the MAC message, control signaling transmission between the UE and the base station can be implemented, where the MAC message carries all parameters of the report indication message.

In the foregoing embodiments, a measurement quantity in the measured and reported parameter includes any one or a combination of the following: a configuration power headroom report; a configuration buffer status report; reference signal received power; reference signal received quality; and a received signal strength indicator.

In this embodiment of the present invention, the measurement quantity in the reported measurement parameter includes any one or a combination of the following: the configuration power headroom report, the configuration buffer status report, the reference signal received power, the reference signal received quality, and the received signal strength indicator, and covers measurement reports required by the base station in various scenarios. Persons skilled in the art may understand that, the measurement quantity may further be a measurement quantity that needs to be obtained by another eNB, such as location information, which is not specially limited in this embodiment of the present invention.

FIG. 10 is a schematic structural diagram of Embodiment 1 of a base station according to the present invention. As shown in FIG. 10, the base station 10 provided in this embodiment of the present invention includes an indication sending module 110, and a report receiving module 120. The indication sending module 110 is configured to send a report indication message of a measurement report to a user equipment UE, where the report indication message includes parameter information that needs to be measured and reported; and the report receiving module 120 is configured to receive a measurement report that is sent by the UE according to the report indication message, where the measurement report includes measurement result information corresponding to the parameter information that needs to be measured and reported.

The base station in this embodiment may be configured to perform the technical solution in the method embodiment shown in FIG. 1, and implementation principles and technical effects of the base station are similar to those of the method and details are not described herein again.

Further, the indication sending module 110 is further configured to send uplink grant information allocated to the UE; and the report receiving module 120 is specifically configured to: receive first measurement result information and identification information of the first measurement result information that are sent by the UE in a Medium Access Control protocol data unit MAC PDU that is encapsulated according to the uplink grant information; and acquire the first measurement result information according to the identification information of the first measurement result information.

The base station in this embodiment may be configured to perform the technical solution in the method embodiment shown in FIG. 2, and implementation principles and technical effects of the base station are similar and details are not described herein again.

Further, the indication sending module is further configured to: if padding exists in the MAC PDU, instruct the UE to send second measurement result information in the padding of the MAC PDU.

The report receiving module is further specifically configured to: receive the second measurement result information and identification information of the second measurement result information that are sent by the UE in the padding of the MAC PDU that is encapsulated according to the uplink grant information; and acquire the second measurement result according to the identification information of the second measurement result information.

The base station in this embodiment may be configured to perform the technical solution in the method embodiment shown in FIG. 3, and implementation principles and technical effects of the base station are similar and details are not described herein again.

Further, the indication sending module is further configured to instruct the UE to send the measurement result information in the padding existing in the MAC PDU.

The report receiving module is specifically configured to: receive the measurement result information and identification information of the measurement result information that are sent by the UE in the padding of the MAC PDU; and acquire a measurement result according to the identification information of the measurement result.

The base station in this embodiment may be configured to perform the technical solution in the method embodiment shown in FIG. 5, and implementation principles and technical effects of the base station are similar and details are not described herein again.

Further, the report indication message is a Radio Resource Control RRC message; and

the RRC message includes either of the following:

an RRC message that is created according to the RRC protocol; and

an RRC message that is obtained by adding an information element to the RRC message.

Further, the report indication message is a Medium Access Control MAC message.

Further, a measurement quantity in the measured and reported parameter includes any one or a combination of the following:

a configuration power headroom report; a configuration buffer status report; reference signal received power; reference signal received quality; and a received signal strength indicator.

The base station in this embodiment may be configured to perform the technical solutions in the foregoing method embodiments, and implementation principles and technical effects of the base station are similar and details are not described herein again.

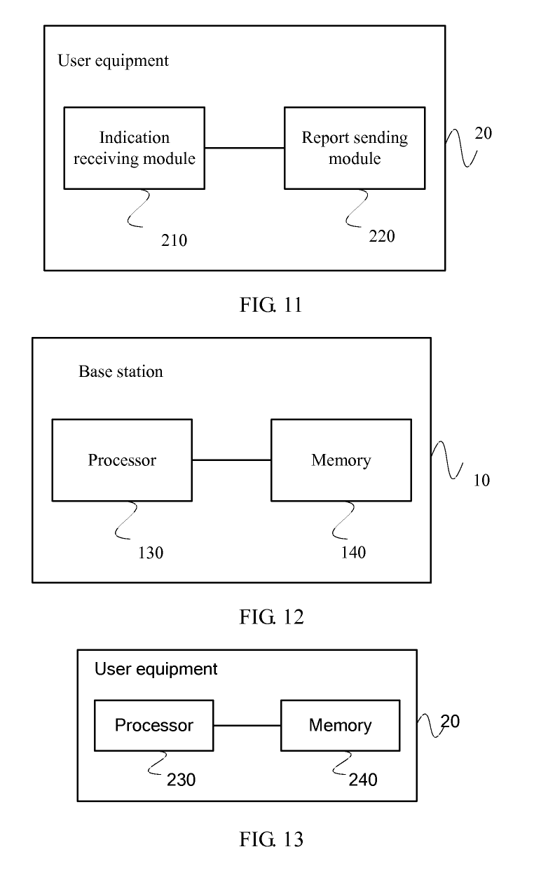

FIG. 11 is a schematic structural diagram of Embodiment 1 of a user equipment according to the present invention. As shown in FIG. 11, the user equipment 20 provided in this embodiment of the present invention includes an indication receiving module 210, and a report sending module 220. The indication receiving module 210 is configured to receive a report indication message sent by a base station, where the report indication message includes parameter information that needs to be measured and reported; and the report sending module 220 is configured to send a measurement report to the base station according to the report indication message, where the measurement report includes measurement result information corresponding to the parameter information that needs to be measured and reported.

The user equipment in this embodiment may be configured to perform the technical solution in the method embodiment shown in FIG. 6, and implementation principles and technical effects of the user equipment are similar and details are not described herein again.

Further, the indication receiving module 210 is further configured to receive uplink grant information.

The report sending module 220 is specifically configured to encapsulate first measurement result information and identification information of the first measurement result information into a Medium Access Control protocol data unit MAC PDU that is encapsulated according to the uplink grant information and send the first measurement result information and the identification information of the first measurement result information to the base station, so that the base station acquires the first measurement result information according to the identification information of the first measurement result information.

The user equipment in this embodiment may be configured to perform the technical solution in the method embodiment shown in FIG. 7, and implementation principles and technical effects of the user equipment are similar and details are not described herein again.

Further, the indication receiving module 210 is further configured to receive indication information that instructs to send second measurement result information in padding of the MAC PDU.

The report sending module 220 is further specifically configured to encapsulate, according to a size of the padding and/or a preset priority of a measurement reporting parameter, the second measurement result information and identification information of the second measurement result information into the padding of the MAC PDU that is encapsulated according to the uplink grant information and send the second measurement result information and the identification information of the second measurement result information to the base station, so that the base station acquires the second measurement result information according to the identification information of the second measurement result information.

The user equipment in this embodiment may be configured to perform the technical solution in the method embodiment shown in FIG. 8, and implementation principles and technical effects of the user equipment are similar and details are not described herein again.

Further, the indication receiving module 210 is further configured to receive indication information that instructs to send the measurement result information in the padding existing in the MAC PDU.

The report sending module 220 is specifically configured to encapsulate, according to a size of the padding and/or a preset priority of a measurement reporting parameter, the measurement result information and identification information of the measurement result information into the padding of the MAC PDU and send the measurement result information and the identification information of the measurement result information to the base station, so that the base station acquires the measurement result information according to the identification information of the measurement result information.

The user equipment in this embodiment may be configured to perform the technical solution in the method embodiment shown in FIG. 9, and implementation principles and technical effects of the user equipment are similar and details are not described herein again.

Further, the report indication message is a Radio Resource Control RRC message; and

the RRC message includes either of the following:

an RRC message that is created according to the RRC protocol; and

an RRC message that is obtained by adding an information element to the RRC message.

Further, the report indication message is a Medium Access Control MAC message.

Further, a measurement quantity in the measured and reported parameter includes any one or a combination of the following:

a configuration power headroom report; a configuration buffer status report; reference signal received power; reference signal received quality; and a received signal strength indicator.

The user equipment in this embodiment may be configured to perform the technical solutions in the foregoing method embodiments, and implementation principles and technical effects of the user equipment are similar and details are not described herein again.

FIG. 12 is a schematic structural diagram of Embodiment 2 of a base station according to the present invention. As shown in FIG. 12, the base station 10 includes a processor 130 and a memory 140, where the memory 140 stores an execution instruction; and when the base station runs, the processor 130 communicates with the memory 140, and the processor 130 executes the execution instruction to enable the base station to perform the foregoing method.

The base station in this embodiment may be configured to perform the technical solutions in the foregoing method embodiments, and implementation principles and technical effects of the base station are similar and details are not described herein again.

FIG. 13 is a schematic structural diagram of Embodiment 2 of a user equipment according to the present invention. As shown in FIG. 13, the user equipment 20 includes a processor 230 and a memory 240, where the memory 240 stores an execution instruction; and when the user equipment runs, the processor 230 communicates with the memory 240, and the processor 230 executes the execution instruction to enable the user equipment to perform the foregoing method.

The user equipment in this embodiment may be configured to perform the technical solutions in the foregoing method embodiments, and implementation principles and technical effects of the user equipment are similar and details are not described herein again.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, as long as such modifications or replacements do not cause the essence of corresponding technical solutions to depart from the scope of the technical solutions of the embodiments of the present invention.

What is claimed is:

1. A measurement report processing method, comprising:
sending a report indication message of a measurement report to a user equipment UE, wherein the report indication message comprises parameter information that needs to be measured and reported; and
receiving a measurement report that is sent by the UE according to the report indication message, wherein the measurement report comprises measurement result information corresponding to the parameter information that needs to be measured and reported.

2. The method according to claim 1, wherein the report indication message further comprises uplink grant information allocated to the UE; and
the receiving a measurement report that is sent by the UE according to the report indication message comprises:
receiving first measurement result information and identification information of the first measurement result information that are sent by the UE in a Medium Access Control protocol data unit MAC PDU that is encapsulated according to the uplink grant information; and
acquiring the first measurement result information according to the identification information of the first measurement result information.

3. The method according to claim 2, wherein if padding exists in the MAC PDU, the report indication message further comprises indication information that instructs the UE to send second measurement result information in the padding of the MAC PDU; and
the receiving a measurement report that is sent by the UE according to the report indication message further comprises:
receiving the second measurement result information and identification information of the second measurement result information that are sent by the UE in the padding of the MAC PDU that is encapsulated according to the uplink grant information; and
acquiring the second measurement result according to the identification information of the second measurement result information.

4. The method according to claim 1, wherein the report indication message further comprises indication information that instructs the UE to send the measurement result information in padding existing in a MAC PDU; and the receiving a measurement report that is sent by the UE according to the report indication message comprises:
receiving the measurement result information and identification information of the measurement result information that are sent by the UE in the padding of the MAC PDU; and
acquiring a measurement result according to the identification information of the measurement result.

5. The method according to claim 1, wherein a measurement quantity in the measured and reported parameter comprises any one or a combination of the following:
a power headroom report;
a buffer status report;
reference signal received power;
reference signal received quality; and
a received signal strength indicator.

6. A measurement report processing method, comprising:
receiving a report indication message sent by a base station, wherein the report indication message comprises parameter information that needs to be measured and reported; and
sending a measurement report to the base station according to the report indication message, wherein the measurement report comprises measurement result information corresponding to the parameter information that needs to be measured and reported.

7. The method according to claim 6, wherein the report indication message further comprises uplink grant information; and
the sending a measurement report to the base station according to the report indication message comprises:
encapsulating first measurement result information and identification information of the first measurement result information into a Medium Access Control protocol data unit MAC PDU that is encapsulated according to the uplink grant information and sending the first measurement result information and the identification information of the first measurement result information to the base station, so that the base station acquires the first measurement result information according to the identification information of the first measurement result information.

8. The method according to claim 7, wherein if padding exists in the MAC PDU, the report indication message further comprises indication information that instructs to send second measurement result information in the padding of the MAC PDU; and
the sending a measurement report to the base station according to the report indication message further comprises:
encapsulating, according to a size of the padding and/or a preset priority of a measurement reporting parameter, the second measurement result information and identification information of the second measurement result information into the padding of the MAC PDU that is encapsulated according to the uplink grant information and sending the second measurement result information and the identification information of the second measurement result information to the base station, so that the base station acquires the second measurement result information according to the identification information of the second measurement result information.

9. The method according to claim 6, wherein the report indication message further comprises indication information that instructs to send the measurement result information in padding existing in a MAC PDU; and
the sending a measurement report to the base station according to the report indication message comprises:
encapsulating, according to a size of the padding and/or a preset priority of a measurement reporting parameter, the measurement result information and identification information of the measurement result information into the padding of the MAC PDU and sending the measurement result information and the identification information of the measurement result information to the base station, so that the base station acquires the measurement result information according to the identification information of the measurement result information.

10. The method according to claim 6, wherein a measurement quantity in the measured and reported parameter comprises any one or a combination of the following:
a configuration power headroom report;
a configuration buffer status report;
reference signal received power;
reference signal received quality; and
a received signal strength indicator.

11. A base station, comprising:
an indication sending module, configured to send a report indication message of a measurement report to a user equipment UE, wherein the report indication message comprises parameter information that needs to be measured and reported; and
a report receiving module, configured to receive a measurement report that is sent by the UE according to the report indication message, wherein the measurement report comprises measurement result information corresponding to the parameter information that needs to be measured and reported.

12. The base station according to claim 11, wherein the indication sending module is further configured to send uplink grant information allocated to the UE; and
the report receiving module is specifically configured to: receive first measurement result information and identification information of the first measurement result information that are sent by the UE in a Medium Access Control protocol data unit MAC PDU that is encapsulated according to the uplink grant information; and acquire the first measurement result information according to the identification information of the first measurement result information.

13. The base station according to claim 12, wherein the indication sending module is further configured to: if padding exists in the MAC PDU, instruct the UE to send second measurement result information in the padding of the MAC PDU; and
the report receiving module is further specifically configured to: receive the second measurement result information and identification information of the second measurement result information that are sent by the UE in the padding of the MAC PDU that is encapsulated according to the uplink grant information; and acquire the second measurement result according to the identification information of the second measurement result information.

14. The base station according to claim 11, wherein the indication sending module is further configured to instruct the UE to send the measurement result information in padding existing in a MAC PDU; and
the report receiving module is specifically configured to: receive the measurement result information and identification information of the measurement result information that are sent by the UE in the padding of the MAC PDU; and acquire a measurement result according to the identification information of the measurement result.

15. The base station according to claim 11, wherein a measurement quantity in the measured and reported parameter comprises any one or a combination of the following:
a configuration power headroom report;
a configuration buffer status report;
reference signal received power;
reference signal received quality; and
a received signal strength indicator.

16. A user equipment, comprising:
an indication receiving module, configured to receive a report indication message sent by a base station, wherein the report indication message comprises parameter information that needs to be measured and reported; and
a report sending module, configured to send a measurement report to the base station according to the report indication message, wherein the measurement report comprises measurement result information corresponding to the parameter information that needs to be measured and reported.

17. The user equipment according to claim 16, wherein the indication receiving module is further configured to receive uplink grant information; and
the report sending module is specifically configured to encapsulate first measurement result information and identification information of the first measurement result information into a Medium Access Control protocol data unit MAC PDU that is encapsulated according to the uplink grant information and send the first measurement result information and the identification information of the first measurement result information to the base station, so that the base station acquires the first measurement result information according to the identification information of the first measurement result information.

18. The user equipment according to claim 17, wherein the indication receiving module is further configured to receive indication information that instructs to send second measurement result information in padding of the MAC PDU; and
the report sending module is further specifically configured to encapsulate, according to a size of the padding and/or a preset priority of a measurement reporting parameter, the second measurement result information and identification information of the second measurement result information into the padding of the MAC PDU that is encapsulated according to the uplink grant information and send the second measurement result information and the identification information of the second measurement result information to the base station, so that the base station acquires the second measurement result information according to the identification information of the second measurement result information.

19. The user equipment according to claim 16, wherein the indication receiving module is further configured to receive indication information that instructs to send the measurement result information in padding existing in a MAC PDU; and
the report sending module is specifically configured to encapsulate, according to a size of the padding and/or a preset priority of a measurement reporting parameter, the measurement result information and identification information of the measurement result information into the padding of the MAC PDU and send the measurement result information and the identification information of the measurement result information to the base station, so that the base station acquires the measurement result information according to the identification information of the measurement result information.

20. The user equipment according to claim 16, wherein a measurement quantity in the measured and reported parameter comprises any one or a combination of the following:
a configuration power headroom report;
a configuration buffer status report;
reference signal received power;
reference signal received quality; and
a received signal strength indicator.
